(19) United States
(12) Patent Application Publication
(10) Pub. No.: US 2025/0146108 A1
(43) Pub. Date: May 8, 2025

(54) TUNGSTEN WIRE AND METAL MESH

(71) Applicant: Panasonic Intellectual Property Management Co., Ltd., Osaka (JP)

(72) Inventors: Tomohiro KANAZAWA, Osaka (JP); Akitoshi KASAHARA, Osaka (JP); Yui NAKAI, Osaka (JP); Masanobu MATSUSHIMA, Shizuoka (JP)

(73) Assignee: Panasonic Intellectual Property Management Co., Ltd., Osaka (JP)

(21) Appl. No.: 18/835,442

(22) PCT Filed: Dec. 21, 2022
(86) PCT No.: PCT/JP2022/047076

§ 371 Date: Aug. 2, 2024

(30) Foreign Application Priority Data
Feb. 10, 2022 (JP) 2022-019243

(51) Int. Cl. C22C 27/04; D03D 15/573; D03D 15/67

(52) U.S. Cl. CPC C22C 27/04; D03D 15/573; D03D 15/67; D10B 2101/20; D10B 2401/063

(57) ABSTRACT

A tungsten wire includes: a metal wire that contains tungsten as a major component; and an oxide film that covers a surface of the metal wire. An average thickness of the oxide film is at least 4 nm and at most 13 nm. A tensile strength of the tungsten wire is at least 3500 MPa.

### TECHNICAL FIELD

The present invention relates to a tungsten wire and a metal mesh.

### BACKGROUND ART

Patent Literature (PTL) 1 discloses a tungsten wire having a diameter of at most 60 μm and a tensile strength of at least 4000 MPa.

### CITATION LIST

### Patent Literature

[PTL 1] Japanese Patent No. 6751900

### SUMMARY OF INVENTION

### Technical Problem

A tungsten wire is high in hardness. Accordingly, when weaving processing, etc. using a tungsten wire is performed, there is a problem that the equipment or component which performs the processing is severely worn away.

In view of the above, an object of the present invention is to provide a tungsten wire and a metal mesh that are capable of inhibiting wear of the equipment or the component.

### Solution to Problem

A tungsten wire according to an aspect of the present invention includes: a metal wire containing tungsten as a major component; and an oxide film that covers a surface of the metal wire. An average thickness of the oxide film is at least 4 nm and at most 13 nm. A tensile strength of the tungsten wire according to this aspect is at least 3500 MPa.

A tungsten wire according to another aspect of the present invention includes: a metal wire containing tungsten as a major component; and an oxide film that covers a surface of the metal wire. The oxide film includes: a graphite film; and a tungsten oxide layer that contains graphite and is located between the graphite film and the metal wire. A tensile strength of the tungsten wire according to this aspect is at least 3500 MPa.

A metal mesh according to an aspect of the present invention includes the tungsten wire according to the above-described one aspect as a warp yarn or a weft yarn.

### Advantageous Effects of Invention

According to the present invention, it is possible to inhibit wear of equipment or a component.

### BRIEF DESCRIPTION OF DRAWINGS

FIG. 1 is a schematic diagram illustrating an external appearance and a cross section of a tungsten wire according to Embodiment 1.

FIG. 2A is a scanning electron microscope (SEM) image of a cross section of a sample of the tungsten wire according to Embodiment 1.

FIG. 2B is an image which shows an oxide film extracted from the SEM image of FIG. 2A.

FIG. 3 is a flowchart illustrating a manufacturing method of the tungsten wire according to Embodiment 1.

FIG. 4 is a diagram illustrating an overview of a wearing test in which the tungsten wire according to Embodiment 1 is used.

FIG. 5 is a diagram illustrating a microgram of an SK material after the wearing test in which the tungsten wire according to Embodiment 1 is used.

FIG. 6 is a graph illustrating a relationship between an average thickness of an oxide film of the tungsten wire and a depth of wear according to Embodiment 1.

FIG. 7 is a schematic diagram illustrating an external appearance and a cross section of a tungsten wire according to Embodiment 2.

FIG. 8 is a flowchart illustrating a manufacturing method of the tungsten wire according to Embodiment 2.

FIG. 9 is a diagram illustrating a microgram of an SK material after the wearing test in which the tungsten wire according to Embodiment 2 is used.

FIG. 10 is a schematic diagram illustrating a metal mesh that is an example of a tungsten product according to Embodiment 3.

FIG. 11 is a schematic diagram illustrating a portion of a twisted wire that is an example of the tungsten product according to Embodiment 3.

FIG. 12 is a schematic diagram illustrating a portion of a rope that is an example of the tungsten product according to Embodiment 3.

### DESCRIPTION OF EMBODIMENTS

Hereinafter, a tungsten wire and a metal mesh according to embodiments of the present invention will be described in detail with referenced to the drawings. It should be noted that each of the embodiments described below shows a specific example of the present invention. As such, the numerical values, shapes, materials, structural components, the arrangement and connection of the structural components, steps, the processing order of the steps, and so on, shown in the following embodiments are mere examples, and therefore do not limit the present invention. Among the structural components in the embodiments described below, those not recited in the independent claims will be described as optional structural components.

In addition, each diagram is a schematic diagram and not necessarily strictly illustrated. Accordingly, for example, scale sizes, etc. are not necessarily exactly represented. In each of the diagrams, substantially the same structural components are assigned with the same reference signs, and redundant descriptions will be omitted or simplified.

In addition, a term representing a relationship between the components as well as a term, such as “circular”, representing a form, and a numerical range are used in the present description. Such terms and range are each not representing only a strict meaning of the term or range, but implying that a substantially same range, e.g., a range that includes even a difference as small as few percentages, is connoted in the term or range.

### Embodiment 1

### [Tungsten Wire]

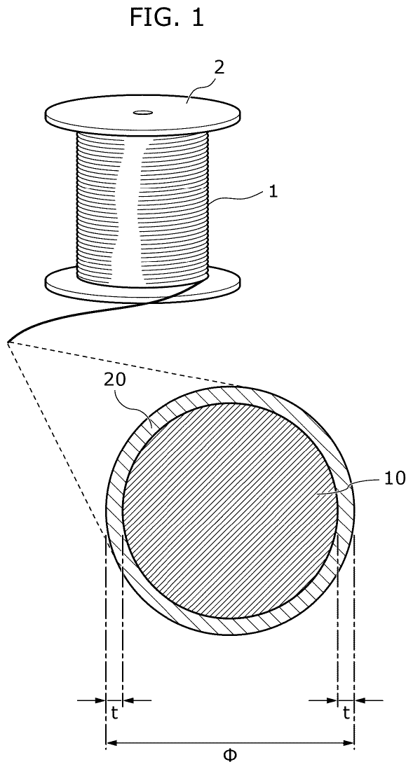

First, a tungsten wire according to Embodiment 1 will be described with referenced to FIG. 1. FIG. 1 is a schematic diagram illustrating an external appearance and a cross section of tungsten wire 1 according to the present embodiment. It should be noted that the thickness of oxide film 20 is exaggerated in the illustration of FIG. 1.

As illustrated in FIG. 1, tungsten wire 1 is wound around winding frame 2 and stored. Winding frame 2 is referred to as a bobbin, reel, spool, or drum in some instances. Tungsten wire 1 has a total length on the order of kilometers, for example, from 50 km or more to 300 km or less.

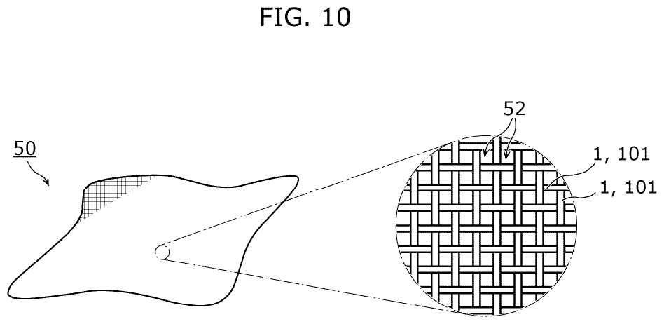

Tungsten wire 1 illustrated in FIG. 1 is utilized in the manufacture of tungsten products. For example, tungsten wire 1 is used as a warp yarn or a weft yarn of a mesh. More specifically, a tungsten mesh is manufactured by performing weaving processing using tungsten wire 1 (see FIG. 10). The tungsten mesh is used for screen printing mesh, cut-resistant clothing, or the like.

Alternatively, tungsten wire 1 is used as a single wire of a twisted wire. More specifically, a twisted wire is manufactured by performing twisting processing using tungsten wire 1 (see FIG. 11). Twisted wires are used for ropes or catheters.

Tungsten wire 1 may be used for a non-woven fabric, a twisted yarn with nylon or the like, and a knitted fabric. More specifically, after cutting processing is performed on tungsten wire 1 to be less than or equal to a predetermined length, non-woven processing is performed to produce a non-woven fabric.

In this manner, various tungsten products using tungsten wire 1 can be manufactured by performing the predetermined processing on tungsten wire 1. At this time, the equipment that performs various processing such as weaving processing, twisting processing, cutting processing, etc. or a component used by the equipment is worn away as a result of contact with tungsten wire 1. Since tungsten wire 1 is hard, the equipment or the component is more likely to be worn away, leading to a shorter life of the equipment or more frequent maintenance.

In contrast, tungsten wire 1 according to the present embodiment includes an oxide film of a desired average thickness on the surface, and thus it is possible to reduce wear of the equipment or the component. The following describes a specific configuration of tungsten wire 1.

The tensile strength of tungsten wire 1 is at least 3500 MPa, but is not limited to this example. The tensile strength of tungsten wire 1 may be at least 4000 MPa, at least 4500 MPa, or at least 5000 MPa. For example, tungsten wire 1 having a tensile strength of 5500 MPa or higher can also be implemented.

The higher the tensile strength of tungsten wire 1 is, the more the occurrence of wire breakage during processing can be suppressed. Accordingly, it is possible to inhibit the decrease in yield of tungsten products. On the other hand, the higher the tensile strength is, the higher the hardness of tungsten wire 1 becomes. Accordingly, the higher the tensile strength is, the more wear of the equipment or a component may increase.

Diameter φ of tungsten wire 1 is at most 80 μm, but is not limited to this example. Diameter φ may be at most 60 μm, at most 35 μm, at most 30 μm, at most 25 μm, at most 20 μm, at most 15 μm, at most 13 μm, at most 11 μm, at most 10 μm, at most 9 μm, at most 8 μm, or at most 7 μm. For example, ultrafine tungsten wire 1 having diameter φ of approximately 5 μm can also be implemented.

The smaller the diameter φ of tungsten wire 1 is, the more useful it is for manufacturing a highly fine mesh and the like. On the other hand, when diameter φ is small, it is necessary to increase the tensile strength for design purposes, and the force applied to the equipment or the component by tungsten wire 1 increases. Therefore, the smaller the diameter φ is, the more wear of the equipment or a component may increase.

Diameter φ is the sum of the diameter of metal wire 10 and twice average thickness t of oxide film 20, as illustrated in FIG. 1. It should be noted that since average thickness t is sufficiently small compared to the diameter of metal wire 10, diameter φ may be regarded as substantially equal to the diameter of metal wire 10.

Tungsten wire 1 includes metal wire 10 and oxide film 20 provide on the surface of metal wire 10.

Metal wire 10 contains tungsten (W) as a major component. The term “major component” means that the content of an element is more than 50 wt %. For example, a tungsten content of metal wire 10 is at least 90 wt %. The tungsten content of metal wire 10 may be at least 95 wt %, at least 99 wt %, at least 99.9 wt %, or at least 99.99 wt %. Metal wire 10 is so-called pure tungsten wire, but may contain inevitable impurities which are inevitably mixed therein through the processes of manufacturing.

Metal wire 10 may be a tungsten alloy wire containing a tungsten alloy which is an alloy of tungsten and metal of at least one type other than tungsten. For example, the metal other than tungsten is rhenium (Re). A rhenium content of metal wire 10 containing a rhenium tungsten alloy (ReW) is, for example, at least 0.1 wt % and at most 10 wt %, but not limited to this example. For example, the rhenium content may be at least 1 wt %, at least 3 wt %, or at least 5 wt %.

When the rhenium content is high, it is possible to increase the tensile strength of metal wire 10. On the other hand, when the rhenium content is excessively high, it is difficult to render metal wire 10 thinner while maintaining a high tensile strength thereof. More specifically, wire breakage is likely to occur, which makes it difficult to perform drawing in long lengths. The workability of metal wire 10 can be enhanced by reducing the rhenium content and setting the tungsten content to at least 90 wt %. In addition, since rhenium is rare and expensive, it is possible to mass-produce in long lengths metal wire 10 which is inexpensive, by reducing the rhenium content.

The metal used for the tungsten alloy may be osmium (Os), ruthenium (Ru), or iridium (Ir). The content of osmium, ruthenium or iridium is equivalent to the content of rhenium, for example. In these cases, the same advantageous effects can be yielded as in the case of a rhenium tungsten alloy. Metal wire 10 may be an alloy wire containing an alloy of tungsten and metal of at least two types other than tungsten.

Metal wire 10 may be a doped tungsten wire doped with potassium (K). Potassium in a potassium-doped tungsten wire is present in the grain boundaries of tungsten. The content of potassium (K) is at most 0.010 wt %, for example. With a potassium-doped tungsten wire, it is also possible to implement a metal wire having a tensile strength higher than a general tensile strength of piano wire. The same advantageous effects can be achieved not only with an oxide of potassium, but also with an oxide of a different substance such as cerium or lanthanum. Metal wire 10 may contain a rare earth element.

Oxide film 20 is an oxide film containing tungsten oxide as a major component. More specifically, oxide film 20 is a film containing tungsten (VI) oxide (WO₃) as a major component. WO₃ is relatively more porous than tungsten (IV) oxide (WO₂) and can function as a buffer against impact. This is due to the difference in film density between WO₃ and WO₂. More specifically, the film density of WO₃ is 7.2 g/cc, while the film density of WO₂ is 10.8 g/cc. In other words, the film density of WO₃ is smaller than the film density of WO₂. It is presumed that the above-described point contributes to the reduction of wear of the equipment or the component. As average thickness t of oxide film 20 increases, WO₂ contained in oxide film 20 increases. As a result, it is presumed that the function as a buffer cannot be sufficiently exerted and the advantageous effect of reduction of wear becomes insufficient.

According to the present embodiment, oxide film 20 is provided in the circumferential direction of the outer surface and in the axial direction, of metal wire 10. For example, oxide film 20 is provided over the entire outer surface of metal wire 10. For example, oxide film 20 is provided with a uniform thickness regardless of the portion. It should be noted that the term “uniform thickness” does not only mean in a strict sense, i.e., that the thickness is constant in every portion, but also means that the variation is within a predetermined range. For example, when the thickness of oxide film 20 is measured at arbitrary 10 points on tungsten wire 1, the maximum-minimum values of variation in the measured value of the thickness is less than or equal to 3 times.

### [Method of Measuring Average Thickness t of Oxide Film]

Average thickness t of oxide film 20 is measured as below.

First, a cross-section of tungsten wire 1 perpendicular to the axial direction is formed. The cross-section is polished by broad ion beam (BIB) processing. More specifically, tungsten wire 1 is irradiated with an argon ion beam, thereby ion-etching the irradiated portion to form a smooth cross-section.

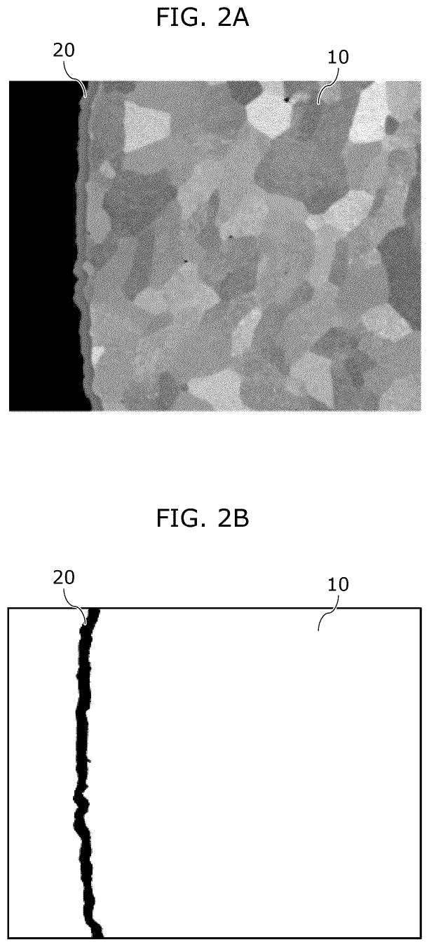

FIG. 2A is a scanning electron microscope (SEM) image of the cross-section of tungsten wire 1 according to the present embodiment. FIG. 2B is an image which shows oxide film 20 extracted from the SEM image of FIG. 2A.

As illustrated in FIG. 2A, in the SEM image, the tungsten crystals included in metal wire 10 can be observed by the difference in color. Furthermore, it can be seen that oxide film 20 is formed along the surface of metal wire 10. Since oxide film 20 can be observed in a different color from the tungsten crystals included in metal wire 10, it is possible to highlight and extract only oxide film 20 as illustrated in FIG. 2B.

Area S of oxide film 20 appearing on the cross-section is measured by image processing. It is possible to calculate average thickness t of oxide film 20, by dividing measured area S by length L of the outer circumference of metal wire 10. Length L can be calculated from the diameter of metal wire 10, by presuming the cross-section of metal wire 10 as circular.

According to the present embodiment, average thickness t of oxide film 20 is at least 4 nm and at most 13 nm. It is possible to reduce wear of the equipment or the component as a result of average thickness t satisfying this range.

### [Manufacturing Method]

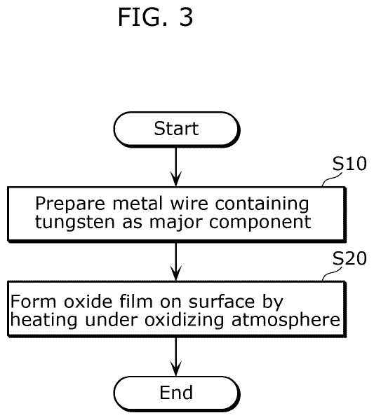

Next, a method of manufacturing tungsten wire 1 according to the present embodiment will be described with referenced to FIG. 3. FIG. 3 is a flowchart illustrating a method of manufacturing tungsten wire 1 according to the present embodiment.

First, metal wire 10 which has a predetermined diameter and a predetermined tensile strength and contains tungsten as a major component is prepared (S10).

For example, first, a tungsten ingot is prepared. More specifically, a tungsten ingot is prepared by pressing and sintering on tungsten powders. At this time, in the case of manufacturing a tungsten alloy wire, pressing and sintering are performed on a mixture of tungsten powders and metal powders for alloying. In the case of a doped tungsten wire, pressing and sintering are performed on doped tungsten powders doped with potassium or the like.

Next, swaging processing and heating are repeatedly performed on the prepared ingot to be a wire of a predetermined diameter (e.g., approximately 3 mm). As a result of the heating, an oxide layer is formed on the surface of the wire, and by impregnating the oxide layer with a lubricant containing carbon (graphite) or the like, it is possible to inhibit the occurrence of wire breakage at the time of wire drawing (drawing processing).

Then, wire drawing (thinning) is performed on the wire using a wire drawing die such as a single crystal diamond die. Wire drawing is performed while heating. Wire drawing is performed repeatedly. In repeated wire drawing, the pore diameter of a die and heating temperature are respectively adjusted to gradually decrease. In this manner, metal wire 10 with high tensile strength is manufactured.

Finally, electrolytic polishing is applied so as to adjust the diameter to be a desired diameter. The electrolytic polishing is carried out, for example, as a result of the generation of a potential difference between metal wire 10 and a counter electrode in a state in which metal wire 10 and the counter electrode are bathed into electrolyte such as aqueous sodium hydroxide.

Then, heating is carried out under a reducing atmosphere so as to once remove substances such as impurities, moisture, etc., adhered through electrolytic polishing. The heating temperature is, for example, at least 600 degrees Celsius and at most 1400 degrees Celsius. After this heating, oxide film 20 is formed on the surface of prepared metal wire 10 (S20). Oxide film 20 is formed by heating metal wire 10 after wire drawing, under an oxidizing atmosphere. By adjusting the heating temperature and heating time, it is possible to control average thickness t of oxide film 20. More specifically, the higher the heating temperature or the longer the heating time is, the larger average thickness t becomes. It should be noted that the heating temperature is, for example, at least 200 degrees Celsius and at most 1200 degrees Celsius, but is not limited to this example.

Metal wire 10 before heating has been electropolished, and thus the oxide layer adhered to the surface at the time of wire drawing has been removed. With this, it is possible to inhibit the variation in thickness of oxide film 20 formed on the surface, and also to form oxide film 20 that is excellent in film quality (i.e., functions as a buffer).

### [Wearing Test]

Next, a wearing test using tungsten wire 1 will be described.

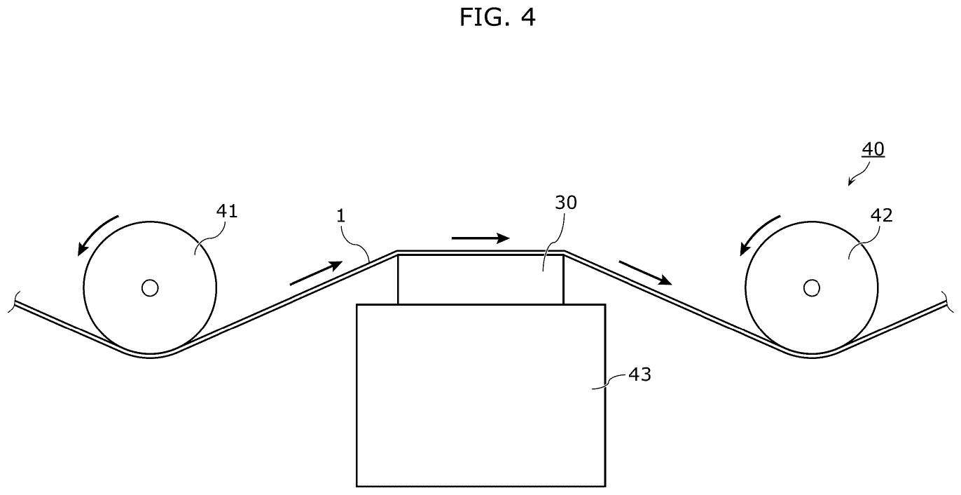

FIG. 4 is a diagram illustrating an overview of a wearing test in which tungsten wire 1 according to the present embodiment is used.

Test equipment 40 illustrated in FIG. 4 is equipment for performing wearing tests. Test equipment 40 includes two rollers 41 and 42 and supporter 43. Two rollers 41 and 42 are bridged by tungsten wire 1 that is to be tested. In the center, SK material (i.e., carbon tool steel) 30 is supported by support 43 so as to be in contact with tungsten wire 1. Tungsten wire 1 is under tension of approximately 10 cN.

Winding frame 2 (not illustrated) on which tungsten wire 1 is wound is located on the roller 41 side, and winding frame (not illustrated) for winding tungsten wire 1 is located on the roller 42 side. As rollers 41 and 42 rotate, tungsten wire 1 is wound from the winding frame on the roller 41 side to the winding frame on the roller 42 side. During the period of winding, tungsten wire 1 slides and runs on the surface of SK material 30 in the axial direction thereof. The speed of the slide-running is 50 m per minute and the running distance is 1000 m.

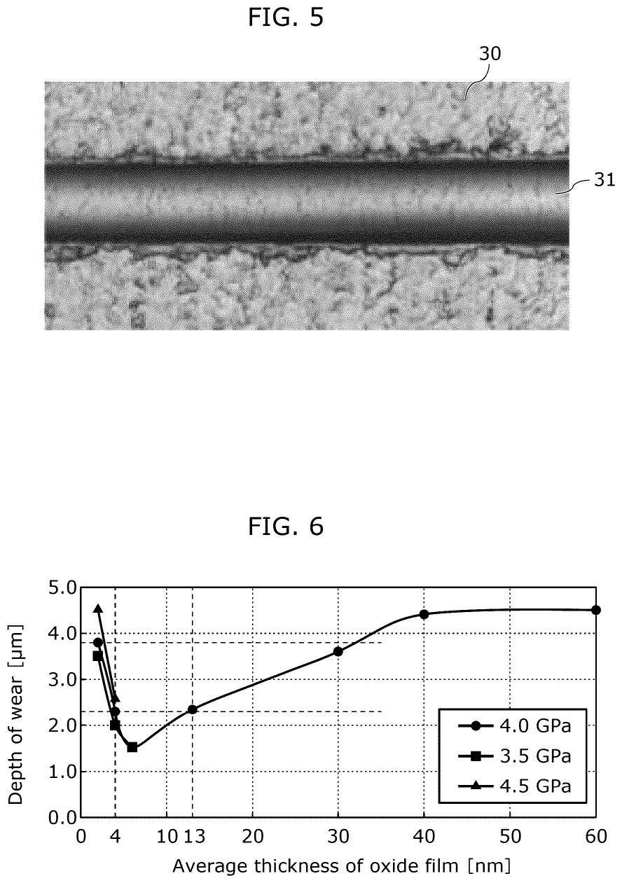

As a result of tungsten wire 1 sliding and running on the surface of SK material 30, groove 31 is formed in SK material 30 as illustrated in FIG. 5. FIG. 5 is a microgram (magnification: 150 times) of SK material 30 after the wearing test. More specifically, FIG. 5 illustrates the state magnified 150 times by a laser microscope. SK material 30 is a steel foil (thickness of SK-2M foil: 0.04 mm). Finally, the depth of groove 31 formed in SK material 30 is measured as the depth of wear. The depth is measured at a point 0.7 mm away from the edge of SK material 30.

Next, a result of the wearing test performed on a sample of tungsten wire 1 manufactured in practice will be described with reference to Table 1 and FIG. 6.

The inventors of the present invention prepared eleven samples (working examples) with different combinations of average thickness t of oxide film 20 and a tensile strength, and performed the above-described wearing test on each of the samples. Average thickness t of oxide film 20 and the tensile strength of each of the samples are as indicated in Table 1. Diameter @ of each of the samples is 11 μm. Average thickness t is a value obtained by adjusting the heating temperature and heating time for each of the samples and measuring the average thickness of oxide film 20 obtained. The tensile strength is a value obtained by adjusting the heating temperature, etc. in the wire drawing processing and measuring the tensile strength of the obtained samples. The tensile strength was measured, for example, based on the tensile test of the Japanese Industrial Standards (JIS H 4460 8).

Table 1 illustrated below indicates, for each of the combinations of average thickness t of oxide film 20 (rows) and the tensile strength (columns), the depth of wear (unit: μm) of SK material 30 for each of the samples.

TABLE 1

| Average thickness t | Tensile strength | | |
|---|---|---|---|
| of oxide film [nm] | 3.5 GPa | 4.0 Gpa | 4.5 GPa |
| 2 | 3.5 μm | 3.8 μm | 4.5 μm |
| 4 | 2.0 μm | 2.3 μm | 2.6 μm |
| 6 | 1.6 μm | 1.6 μm | — |
| 13 | — | 2.3 μm | — |
| 30 | — | 3.6 μm | — |
| 40 | — | 4.4 μm | — |
| 60 | — | 4.5 μm | — |

FIG. 6 is a graph illustrating a relationship between average thickness t of oxide film 20 of tungsten wire 1 and the depth of wear according to the present embodiment. In FIG. 6, the horizontal axis represents average thickness t of oxide film 20 (unit: nm) and the vertical axis represents the depth of wear of SK material 30 (unit: μm). FIG. 6 is a graphical representation of Table 1.

Focusing on the case where the tensile strength is 4.0 GPa, it can be seen that as average thickness t of oxide film 20 increases, the depth of wear decreases and then begins to increase after reaching a minimal value. For example, when average thickness t is 4 nm, the depth of wear is 2.3 μm, which means a reduction to approximately 60% of the depth of wear when average thickness t is 2 nm (depth of wear=3.8 μm). Furthermore, when average thickness t is 6 nm, the depth of wear is 1.6 μm, which means a reduction to approximately 42% of the depth of wear when average thickness t is 2 nm.

Such a tendency of decreasing depth of wear is observed for both of the case where tensile strength is 3.5 GPa and the case where tensile strength is 4.5 GPa. Regardless of the tensile strength of tungsten wire 1, the depth of wear decreases in the range of average thickness t from 4 nm to 6 nm, which means a reduction to approximately 60% or less than the depth of wear when average thickness t is 2 nm.

Focusing again on the case where tensile strength is 4.0 GPa, when average thickness t of oxide film 20 is 13 nm, the depth of wear is substantially the same as the depth of wear when average thickness t is 4 nm. As average thickness t increases, the depth of wear tends to increase. When the average thickness is at least 40 nm, the depth of wear is substantially constant. From this, it is estimated that the same tendency can also be seen for the case where tensile strength is 3.5 GPa and the case where tensile strength is 4.5 GPa.

Oxide film 20 that contains WO₃ as the major component is more porous than metal wire 10, and can function as a buffer against impact. For that reason, it can be assumed that as average thickness t of oxide film 20 increases, oxide film 20 functions sufficiently as a buffer to decrease the depth of wear. On the other hand, when average thickness t of oxide film 20 increases excessively, the proportion of WO₂ included in oxide film 20 increases and the proportion of WO₃ decreases. It can be assumed that the depth of wear does not decrease because WO₂ has a higher film density than WO₃, and thus cannot sufficiently function as a buffer.

In view of the above, it can be seen that the depth of wear can be decreased in the range where average thickness t of oxide film 20 is at least 4 nm to 13 nm. In particular, in the range where average thickness t is 6 nm and its vicinity (e.g., at least 5 nm and at most 7 nm), the amount of decrease in depth of wear is significant, and the depth of wear can be decreased to less than or equal to half of the depth of wear in the case where average thickness t is 2 nm. In addition, for example, in the range where average thickness t is at least 5 nm and at most 10 nm, the depth of wear is at most 2.0 μm even in the sample with the tensile strength of 4.0 GPa, and the depth of wear can be decreased same as or more than the sample with the tensile strength of 3.5 GPa and average thickness t of oxide film 20 of 4 nm.

Since the contribution of oxide film 20 to the decrease of depth of wear is high, it is estimated that the same tendency is obtained even when the tensile strength is greater than 4.5 GPa, for example, at least 5.0 GPa and at most 6.0 GPa, or when diameter φ is different.

### Advantageous Effects, Etc.

As described above, tungsten wire 1 according to the present embodiment includes metal wire 10 containing tungsten as a major component, and oxide film 20 that covers the surface of metal wire 10. Average thickness t of oxide film 20 is at least 4 nm and at most 13 nm. The tensile strength of tungsten wire 1 is at least 3500 MPa.

With the above-described configuration, it is possible to inhibit wear of processing equipment or a component of tungsten wire 1.

In addition, for example, diameter q of tungsten wire 1 may be at most 80 μm.

With this configuration, when diameter φ is small, the force applied by tungsten wire 1 increases and wear also tends to increase, and thus the advantageous effect of inhibiting wear by oxide film 20 is more useful.

In addition, for example, the tensile strength of tungsten wire 1 may be at least 4000 MPa.

With this configuration, when the tensile strength is high, the hardness of tungsten wire 1 is also high and wear also tends to increase, and thus the advantageous effect of inhibiting wear by oxide film 20 is more useful.

In addition, for example, tungsten wire 1 is used as a warp yarn or a weft yarn of a mesh.

With this configuration, it is possible to inhibit wear of equipment or a component used in the weaving processing.

In addition, for example, tungsten wire 1 may be used as a single wire of a twisted wire.

With this configuration, it is possible to inhibit wear of equipment or a component used in the wire twisting processing.

### Embodiment 2

Next, Embodiment 2 will be described.

Embodiment 2 differs from Embodiment 1 mainly in that a graphite film is provided on the topmost surface of the oxide film. The following describes Embodiment 2 with a focus on the differences from Embodiment 1, and the explanation of common points will be omitted or simplified.

### [Tungsten Wire]

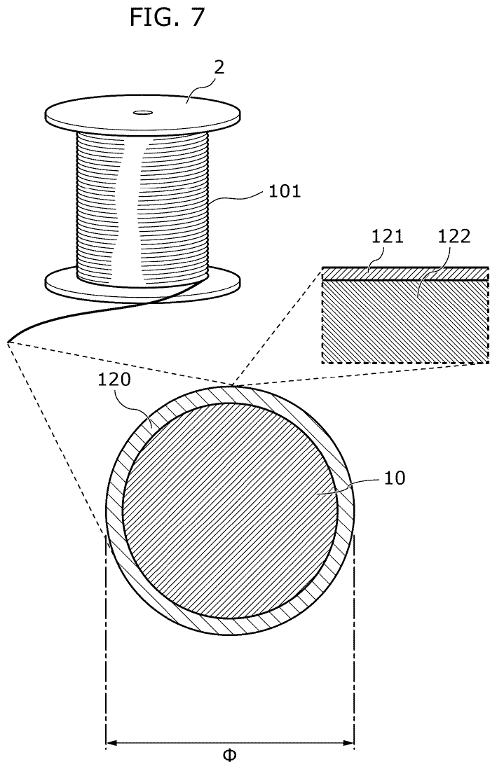

FIG. 7 is a schematic diagram illustrating an external appearance and a cross section of tungsten wire 101 according to Embodiment 2. It should be noted that the thickness of oxide film 120 is exaggerated in the illustration of FIG. 7.

As illustrated in FIG. 7, tungsten wire 101 includes oxide film 120 instead of oxide film 20 as compared to tungsten wire 1 according to Embodiment 1. Oxide film 120 includes graphite film 121 and tungsten oxide layer 122. It should be noted that the layer structure of oxide film 120 is exaggerated in the illustration of FIG. 7.

Graphite film 121, for example, is located on the topmost surface of oxide film 120, and is a layer including graphite. Graphite film 121 contains substantially no tungsten.

Tungsten oxide layer 122 is a layer that contains graphite and is located between graphite film 121 and metal wire 10. Tungsten oxide layer 122 includes tungsten oxide (WO₃) as a major component, and is formed by impregnation of graphite from the surface side (graphite film 121 side). In tungsten oxide layer 122, the content of graphite is not uniform in the thickness direction. More specifically, the closer to graphite film 121, the higher the content of graphite, and the closer to metal wire 10, the lower the content of graphite. The graphite content substantially increases with decreasing distance from graphite film 121, and the portion where the graphite content can finally be regarded as 100% is graphite film 121. In other words, in practice, graphite film 121 and tungsten oxide layer 122 are not clearly distinguishable layers as illustrated in FIG. 7.

According to the present embodiment, the thickness of oxide film 120 is not specifically limited. Oxide film 120 is provided to hold graphite and form graphite film 121 on the topmost surface layer. For that reason, the thickness of oxide film 120 is sufficient as long as a certain amount of graphite can be contained. As an example, the thickness of oxide film 120 can be at least 30 nm and at most 500 nm. For example, when tungsten wire 101 of 13 μm is manufactured by performing the drawing processing at a heating temperature of approximately 600 degrees Celsius according to a manufacturing method described below, oxide film 120 of approximately 30 nm is formed. In the same manner as above, when tungsten wire 101 of 80 μm is manufactured by performing the drawing processing at a heating temperature of approximately 600 degrees Celsius, oxide film 120 of approximately 500 nm is formed. In this manner, it is possible to form oxide film 120 of different thicknesses according to the diameter of tungsten wire 101. The thickness of oxide film 120 is not limited to the above-described example as long as the graphite can be held.

According to the present embodiment, graphite film 121 is provided, and thus the smoothness of sliding on the surface of tungsten wire 101 is improved. Accordingly, wear due to tungsten wire 101 is inhibited.

It should be noted that diameter φ and the tensile strength of tungsten wire 101 and the specific configuration (tungsten content and other elemental content) of metal wire 10 according to the present embodiment are the same as those of tungsten wire 1 according to Embodiment 1. For example, the tensile strength of tungsten wire 101 is at least 3500 MPa, but is not limited to this example. The tensile strength of tungsten wire 101 may be at least 4000 MPa, at least 4500 MPa, or at least 5000 MPa, and it is also possible to implement tungsten wire 101, for example, with a high tensile strength of at least 5500 MPa.

### [Manufacturing Method]

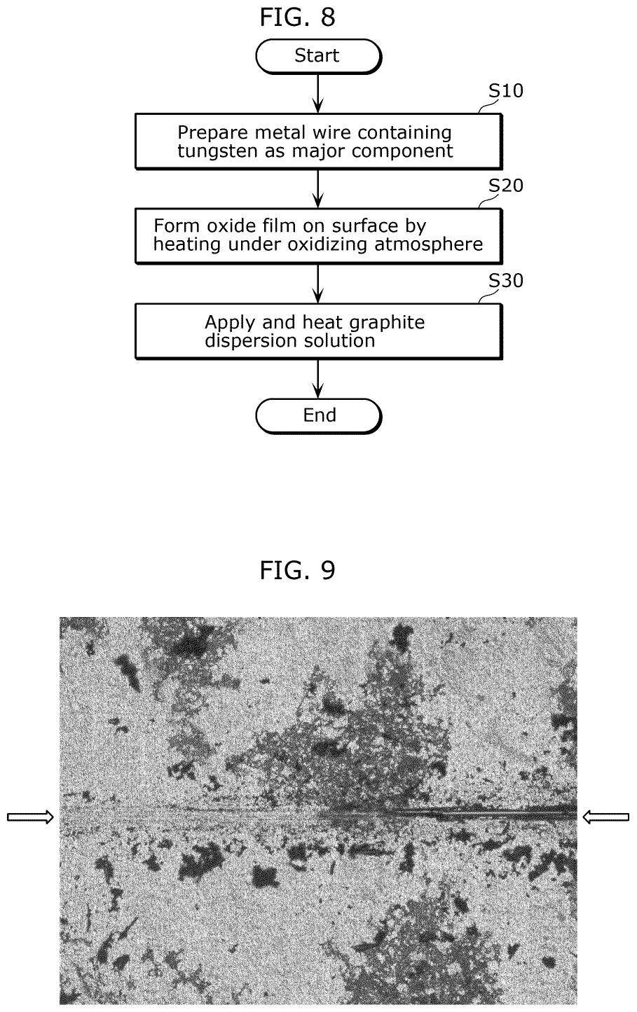

Next, a method of manufacturing tungsten wire 101 according to the present embodiment will be described with reference to FIG. 8. FIG. 8 is a flowchart illustrating the method of manufacturing tungsten wire 101 according to the present embodiment.

First, metal wire 10 having a predetermined diameter and a tensile strength, and containing tungsten as a major component is prepared (S10). The details of the preparation of metal wire 10 (S10) are the same as those in Embodiment 1. Electrolytic polishing is performed at the end of the preparation of metal wire 10, and thus it is possible to easily adjust diameter P.

Then, heating is carried out under a reducing atmosphere so as to once remove substances such as impurities, moisture, etc., adhered through electrolytic polishing. The heating temperature is, for example, at least 600 degrees Celsius and at most 1400 degrees Celsius. Then, an oxide film is formed on the surface of metal wire 10 prepared (S20). The details of the formation of the oxide film are the same as those in Embodiment 1.

It should be noted that, as described above, the oxide film that covers metal wire 10 according to the present embodiment is provided for the purpose of impregnating and holding graphite, and thus there may be variations in film quality and thickness. For that reason, for example, heating under a reducing atmosphere for the purpose of removing impurities, etc. may be omitted. In addition, the heating temperature and heating time may be adjusted as appropriate.

Next, a graphite dispersion solution is applied to the surface of oxide film 120 and heated (S30). While impregnating the oxide film with graphite contained in the graphite dispersion solution, the solution component is evaporated by heating. The graphite dispersion solution is, for example, water in which carbon (graphite) is dispersed. The graphite dispersion solution contains a few percent of a dispersant for dispersing the graphite in the solution. In this manner, oxide film 120 that includes graphite film 121 and tungsten oxide layer 122 is formed.

Through the above-described processes, tungsten wire 101 according to the present embodiment is manufactured.

### [Wearing Test]

Next, a result of the wearing test using tungsten wire 101 according to the present embodiment will be described. The details of the wearing test are the same as those in Embodiment 1.

FIG. 9 is a diagram illustrating a microgram (magnification: 10 times) of an SK material after the wearing test in which tungsten wire 101 according to the present embodiment is used. In the wearing test, a sample of tungsten wire 101 was caused to slide and run on the portion sandwiched by the arrows located on the left and right sides of FIG. 9. The sample used was a tungsten wire manufactured according to the manufacturing method indicated in FIG. 8, with diameter φ of 13 μm. The SK material is the same as the SK material used in Embodiment 1, and is steel foil (thickness of SK-2M foil: 0.04 mm).

As illustrated in FIG. 9, a slight trace of contact with tungsten wire 101 was observed, but a clearly discernible “groove” was not observed. The result of measuring the depth of the “groove” (depth of wear) in practice based on the same procedure as in Embodiment 1 was 0.0 μm. In other words, no groove with a depth of 0.1 μm or greater was observed.

### Conclusion

As described above, tungsten wire 101 according to the present embodiment includes metal wire 10 containing tungsten as a major component, and oxide film 120 that covers the surface of metal wire 10. Oxide film 120 includes graphite film 121 and tungsten oxide layer 122 that contains graphite and is located between graphite film 121 and metal wire 10. The tensile strength of tungsten wire 101 is at least 3500 MPa.

With the above-described configuration, it is possible to inhibit wear of processing equipment or a component of tungsten wire 101.

In addition, for example, diameter q of tungsten wire 101 may be at most 80 μm.

With this configuration, when diameter φ is small, the force applied by tungsten wire 101 increases and wear also tends to increase, and thus the advantageous effect of inhibiting wear by oxide film 120 is more useful.

In addition, for example, the tensile strength of tungsten wire 101 may be at least 4000 MPa.

With this configuration, when the tensile strength is high, the hardness of tungsten wire 101 is also high and wear also tends to increase, and thus the advantageous effect of inhibiting wear by oxide film 120 is more useful.

In addition, for example, tungsten wire 101 may be used as a warp yarn or a weft yarn of a mesh

With this configuration, it is possible to inhibit wear of equipment or a component used in the weaving processing.

In addition, for example, tungsten wire 101 may be used as a single wire of a twisted wire.

With this configuration, it is possible to inhibit wear of equipment or a component used in the wire twisting processing.

### Embodiment 3

Next, Embodiment 3 will be described.

In Embodiment 3, a tungsten product manufactured by processing tungsten wire 1 according to Embodiment 1 or tungsten wire 101 according to Embodiment 2 will be described. The following describes Embodiment 3 with a focus on the differences from Embodiment 1 or 2, and the explanation of common points will be omitted or simplified.

### [Metal Mesh]

FIG. 10 is a schematic diagram illustrating tungsten mesh 50 that is an example of a tungsten product according to the present embodiment. In FIG. 10, the mesh is schematically illustrated only on a portion of tungsten mesh 50, but the entire tungsten mesh 50 is in a mesh-like state.

Tungsten mesh 50 is an example of a metal mesh and includes a plurality of tungsten wires 1 or 101 as warp and weft yarns. In other words, tungsten mesh 50 is manufactured by weaving using a plurality of tungsten wires 1 or 101 as warp and weft yarns.

Tungsten mesh 50 is, for example, a mesh for screen printing (referred to as a screen printing mesh). Tungsten mesh 50 includes a plurality of openings 52. Openings 52 are the portions through which ink passes in screen printing. By blocking a portion of openings 52 with an emulsion or resin (e.g., polyimide), a non-passing portion through which ink cannot pass is formed. By patterning the shape of the non-passing portion into any desired shape, screen printing can be performed in the desired shape.

It should be noted that, in tungsten mesh 50, all warp yarns and all weft yarns can be the same type of tungsten wire 1 or 101, but the present invention is not limited to this. Tungsten wire 1 and tungsten wire 101 may be used in an intermixed manner in the warp and weft yarns. Alternatively, one of the warp yarns and the weft yarns may be other than tungsten wire 1 or 101. For example, tungsten wire 1 or 101 may be used for one of the warp yarns and the weft yarns, and stainless steel wire may be used for the other of the warp yarns and the weft yarns.

### [Twisted Wire and Rope]

FIG. 11 is a schematic diagram illustrating a portion of twisted wire 60 that is an example of the tungsten product according to the present embodiment.

As illustrated in FIG. 11, twisted wire 60 includes a plurality of tungsten wires 1 or 101. Twisted wire 60 is manufactured by twisting the plurality of tungsten wires 1 or 101 together as strands.

Twisted wire 60 is a piled yarn obtained by performing doubling and twisting processing on the plurality of tungsten wires 1 or 101, for example Alternatively, twisted wire 60 is a covered yarn obtained by performing covering processing on the plurality of tungsten wires 1 or 101. It should be noted that all of the plurality of strands included in twisted wire 60 can be the same type of tungsten wire 1 or 101, but the present invention is not limited to this. For example, twisted wire 60 may be configured by twisting together at least one tungsten wire 1 and at least one tungsten wire 101. Alternatively, twisted wire 60 may be configured by twisting together at least one tungsten wire 1 or 101 and at least one stainless steel wire.

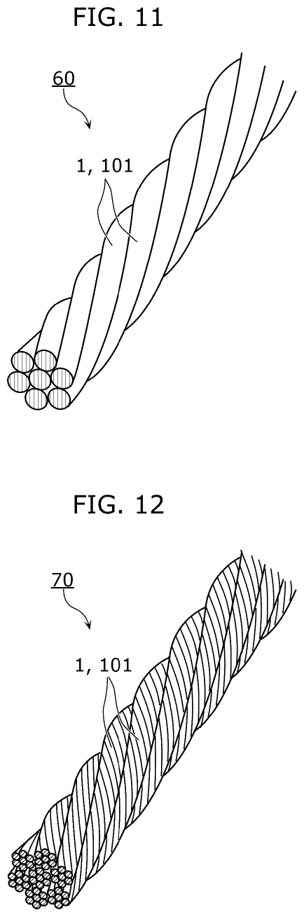

In addition, as illustrated in FIG. 12, rope 70 may be manufactured by further twisting together twisted wires 60. FIG. 12 is a schematic diagram illustrating a portion of rope 70 that is an example of the tungsten product according to the present embodiment.

As illustrated in FIG. 12, rope 70 is manufactured by twisting together a plurality of twisted wires 60 as small ropes (strands). It is possible to increase the strength of rope 70 by making a twisting direction (e.g., S-twist) of rope 70 different from a twisting direction of twisted wire 60 (e.g., Z-twist).

It should be noted that a total number of tungsten wires 1 or 101 and a total number of twists used for twisting each of twisted wires 60 and ropes 70 are not particularly limited.

Wear occurring on equipment or a component at the time of manufacturing of the above-described tungsten mesh 50, twisted wire 60, and rope 70 could also lead to damage on tungsten wire 1 or 101. With tungsten wire 1 or 101 according to the present embodiment, wear of the equipment or a component can be inhibited, and as a result, it is possible to implement tungsten products such as tungsten mesh 50, twisted wire 60, and rope 70 of excellent quality.

### (Others)

Although the tungsten wire and the tungsten products such as the metal mesh according to the present invention have been described thus far based on the above-described embodiments, the present invention is not limited to the above-described embodiments.

For example, oxide film 20 may be a natural oxide film. In other words, oxide film 20 may be formed by storing metal wire 10 in air after electrolytic polishing, without performing heating processing under an oxidizing atmosphere. In this case, the storage condition of metal wire 10 may be changed periodically to control the variation of average thickness t of oxide film 20.

In addition, for example, it is also possible to inhibit wear of equipment or a component even when metal wire 10 is used in a state in which no electrolytic polishing is performed and a carbon coating film is formed on the oxide layer in the manufacturing processes of tungsten wire 1 or 101. In other words, in the flowchart illustrated in FIG. 8, the electrolytic polishing in the final process in the preparation of metal wire 10, formation of the oxide layer (S20), and application and heating of the graphite dispersion film (S30) may be omitted. Since a lubricant containing graphite is used in the wire drawing processing, an oxide film having the same configuration as oxide film 120 can be formed on the surface of metal wire 10, by the annealing processing or the heating processing during the wire drawing processing.

In addition, for example, the same advantageous effects can be yielded by applying a solid lubricant and powders other than tungsten to the surface, or by applying and drying a liquid.

It should be noted that the present invention also includes other forms in which various modifications apparent to those skilled in the art are applied to the embodiments or forms in which structural components and functions in the embodiments are arbitrarily combined within the scope of the present disclosure.

### REFERENCE SIGNS LIST

1, 101 tungsten wire
10 metal wire
20, 120 oxide film
50 tungsten mesh (metal mesh)
60 twisted wire
121 graphite film
122 tungsten oxide layer

1. A tungsten wire comprising:
a metal wire containing tungsten as a major component; and
an oxide film that covers a surface of the metal wire, wherein
an average thickness of the oxide film is at least 4 nm and at most 13 nm, and
a tensile strength of the tungsten wire is at least 3500 MPa.

2. A tungsten wire comprising:
a metal wire containing tungsten as a major component; and
an oxide film that covers a surface of the metal wire, wherein
the oxide film includes:
a graphite film; and
a tungsten oxide layer that contains graphite and is located between the graphite film and the metal wire, and
a tensile strength of the tungsten wire is at least 3500 MPa.

3. The tungsten wire according to claim 1, wherein
a diameter of the tungsten wire is at most 80 μm.

4. The tungsten wire according to claim 1, wherein a tensile strength of the tungsten wire is at least 4000 MPa.

5. The tungsten wire according to claim 1, wherein the tungsten wire is used as a warp yarn or a weft yarn of a mesh.

6. The tungsten wire according to claim 1, wherein the tungsten wire is used as a single wire of a twisted wire.

7. A metal mesh comprising:
the tungsten wire according to claim 1 as a warp yarn or a weft yarn.

8. The metal mesh according to claim 7, wherein
the metal mesh is used as a screen printing mesh.

9. The tungsten wire according to claim 2, wherein
a diameter of the tungsten wire is at most 80 μm.

10. The tungsten wire according to claim 2, wherein
a tensile strength of the tungsten wire is at least 4000 MPa.

11. The tungsten wire according to claim 2, wherein
the tungsten wire is used as a warp yarn or a weft yarn of a mesh.

12. The tungsten wire according to claim 2, wherein
the tungsten wire is used as a single wire of a twisted wire.

13. A metal mesh comprising:
the tungsten wire according to claim 2 as a warp yarn or a weft yarn.

14. The metal mesh according to claim 13, wherein
the metal mesh is used as a screen printing mesh.
